(19) United States
(12) Patent Application Publication
(10) Pub. No.: US 2006/0200658 A1
(43) Pub. Date: Sep. 7, 2006

(54) Agent framework for mobile devices

(75) Inventor: Jason David Penkethman, Aliso Viejo, CA (US)

Correspondence Address: MCANDREWS HELD & MALLOY, LTD, 500 WEST MADISON STREET, SUITE 3400, CHICAGO, IL, 60661, US

(73) Assignee: BitFone Corporation

(21) Appl. No.: 11/369,561

(22) Filed: Mar. 7, 2006

Related U.S. Application Data
(60) Provisional application No. 60/659,748, filed on Mar. 7, 2005.

(51) Int. Cl. G06F 9/24

(52) U.S. Cl. 713/2

(57) ABSTRACT

Herein described is an agent support framework used in a mobile communication device. The agent support framework provides a set of commonly used features that may be used by various client applications. The client applications may comprise one or more diagnostic/configuration agents that are used in monitoring device status, performing problem diagnosis, and obtaining configuration information from the mobile electronic device. Should a firmware or file system update be required, one or more update agents may be used to download one or more data files. The set of commonly used features provides shared resources to the various client applications. New client applications may be easily designed based on the set of commonly used features. The integration of new agents and/or clients to the agent support framework is facilitated by the ability of the agent support framework to provide shared resources when necessary.

### CROSS-REFERENCE TO RELATED APPLICATIONS/INCORPORATION BY REFERENCE

The present application makes reference to, claims priority to, and claims benefit of U.S. Provisional Patent Application Ser. No. 60/659,748 entitled “AGENT FRAMEWORK FOR MOBILE DEVICES”, filed Mar. 7, 2005, the complete subject matter of which is hereby incorporated herein by reference, in its entirety.

The present application makes reference to PCT Application with publication number WO/02/41147 A1, PCT number PCT/US01/44034, filed Nov. 19, 2001, and to U.S. Provisional Patent Application Ser. No. 60/249,606, filed Nov. 17, 2000, the complete subject matter of each of which is hereby incorporated herein by reference, in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Mobile phones have evolved into extremely sophisticated devices, providing a wide range of voice, data, entertainment and messaging services. While this provides new revenue opportunities for both network operators and device manufacturers, this increase in software complexity has significantly increased customer support costs and the risk of device configuration issues, software bugs, application compatibility, and product recalls. Also, the ability to drive device and service adoption in order to increase revenues relies heavily on improving and maintaining a high quality end-user experience. The increase in device sophistication should not require increased end-user knowledge of how to configure, troubleshoot or maintain those services. In fact we would expect that most issues, however complex, would be resolved either transparently to the user or with minimum interaction.

Electronic devices, such as mobile phones and personal digital assistants (PDA's), often contain firmware and application software that are either provided by the manufacturers of the electronic devices, by telecommunication carriers, or by third parties. If firmware or firmware components are to be changed in electronic devices, it is often difficult to update the firmware components. In some instances, the codes or functions that are used to update firmware or firmware components may have to be changed or updated. Such codes or functions, when upgraded, may not fit into the space available in the electronic device (FLASH or other storage). Changes to firmware or firmware components must be performed in a fault tolerant mode and fault tolerant codes are not easy to implement.

Typically one device at a time will be updated. However, if an operator needs to update millions of phones, updating one device at a time could be slow. There is no easy way to conduct mass updates of millions of devices, such as mobile handsets.

Typically, multiple functions are required in a phone that can be updated. However, a different client may be needed for each of these multiple functions. The interactions between these clients can be complicated in a device. Often, one client, while executing, may make another client inoperable or slow. In addition, the resources needed by these different clients can be quite large, and if they are all installed and running, might use up all the resources available in the device.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Aspects of the present invention provide at least a system and/or method for managing a mobile communications electronic device by way of a commonly shared agent support framework, substantially as shown in and/or described in connection with at least one of the figures, as set forth more completely in the claims.

These and other advantages and novel features of the present invention, as well as details of an illustrated embodiment thereof will be more fully understood from the following description and drawings.

### BRIEF DESCRIPTION OF THE DRAWINGS

FIG. 1 shows a communication network supporting the management of an electronic device served via a wireless infrastructure, in which a representative embodiment of the present invention may be practiced.

FIG. 2 is a block diagram of an exemplary network that is capable of monitoring, diagnosing, and resolving issues associated with the operation of an electronic device corresponding to, for example, the electronic device of FIG. 1, in accordance with a representative embodiment of the present invention.

FIG. 3 is a relational block diagram illustrating various modular software components integrated within an exemplary software platform of an electronic device, such as the electronic device previously described in relation to FIGS. 1 and 2, in accordance with an embodiment of the present invention.

FIG. 4 is an operational flow diagram showing an exemplary firmware over-the-air (OTA) session between an electronic device and one or more servers in a network, in accordance with an embodiment of the present invention.

FIG. 5 is a functional block diagram illustrating the various modular software components in an exemplary software platform of an electronic device used in conjunction with a mobile variance agent (MVA), in accordance with an embodiment of the present invention.

FIG. 6 is an operational block diagram that illustrates an exemplary operation of an MVA 604 with its corresponding server 612, in accordance with an embodiment of the present invention.

FIG. 7 is an operational block diagram illustrating an exemplary diagnostics and configuration session provided by a diagnostics/configuration agent 704 and its corresponding diagnostics/configuration server 708, in accordance with an embodiment of the invention.

FIG. 8 is a functional block diagram illustrating the various modular software components in an exemplary software platform of an electronic device used in conjunction with the diagnostics/configuration agent, in accordance with an embodiment of the present invention.

### DETAILED DESCRIPTION OF THE INVENTION

The present invention relates generally to the management of electronic devices. In a representative embodiment, the electronic devices comprise mobile communication devices. Examples of mobile communication devices include cellular phones, pagers, personal digital assistants (PDAs), etc. Aspects of the present invention relate to the use of an agent support framework to monitor, diagnose, and resolve software and/or hardware issues of the electronic devices. Further aspects of the present invention allow updating firmware/software within the electronic devices over-the-air (OTA). In a representative embodiment, the agent support framework may incorporate one or more libraries/services which may be commonly shared by one or more agents. The one or more agents may comprise software code used for enabling effective and efficient over-the-air (OTA) device management (DM) functionality of the electronic devices in a communication network. The electronic devices may communicate to one or more servers in the communication network. In a representative embodiment, the electronic devices and one or more servers may conform to standards and protocols specified by the Open Mobile Alliance (OMA), for example. The various aspects of the present invention may provide significant benefits to network operators and device manufacturers by not only providing comprehensive device management capabilities, but by providing a flexible and modular design that allows the possibility to share resources more efficiently between one or more software clients or agents. Other aspects of the invention are related to reducing the effort required to integrate future device management services and functionality by way of incorporating additional software clients or agents.

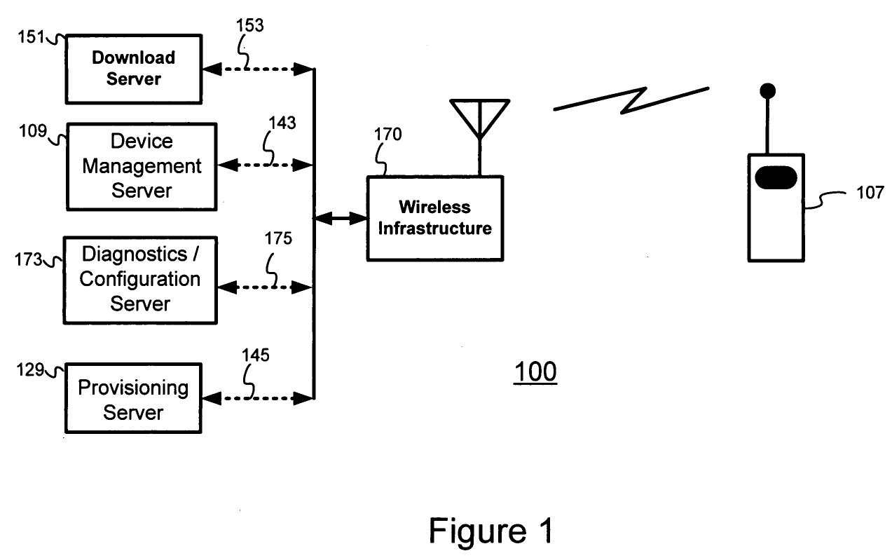

FIG. 1 illustrates an exemplary communication network 100 supporting management of an electronic device 107 served via a wireless infrastructure 170, in which a representative embodiment of the present invention may be practiced. The wireless infrastructure may employ one or more communication protocols such as CDMA, GSM, GPRS, WCDMA, and the like. One or more servers 151, 109, 173, 129 are communicatively coupled to a wireless infrastructure 170, through one or more corresponding communication paths 145, 143, 175, and 153. The wireless infrastructure 170 is communicatively coupled to the electronic device 107. In a representative embodiment, the electronic device 107 may comprise a mobile communication electronic device such as a wireless or cellular telephone. Referring to FIG. 1, the communication paths 145, 143, 175, and 153, illustrated in dotted lines, may comprise a wired or wireless communication link such as, for example, an intranet, the Internet, a wired or wireless local area network, a packet network, or any other suitable form of communication link. In a representative embodiment, the wireless infrastructure 170 may be owned and operated by a telecommunications carrier or operator, for example. The wireless infrastructure 170 may comprise, for example, a cellular network, a paging network, a wireless local and/or wide area network, or other suitable wireless communication network. Although the wireless infrastructure 170 is shown as a single entity having a single antenna location, this does not represent a specific limitation of the present invention. A representative embodiment of the present invention may comprise a greater number of antenna locations including those belonging to separate services providers, without departing from the scope of the present invention.

The communication network 100 comprises a provisioning server 129, that may also be referred to herein as a “broadcast server”, and a device management (DM) server 109 that may support, for example, an Open Mobile Alliance (OMA) device management (DM) protocol, or a proprietary protocol. The provisioning server 129 may be used to provision one or more settings of the electronic device 107 via the use of a short message service (SMS) or hypertext transport protocol (HTTP). The communication network 100 also comprises a download server 151 for downloading update packages to the electronic device 107. In a representative embodiment of the present invention, an update package may, among other things, comprise a set of instructions executable by a software agent in the electronic device 107. The agent may be used to convert or transform an existing version of software and/or firmware code to an updated version. A diagnostics/configuration server 173 may be used for communicating to the electronic device 107, for providing discovery of the electronic device's configuration, hardware/software versions, and settings, for example.

As shown in the illustration of FIG. 1, the provisioning server 129, a DM server 109, a diagnostics/configuration server 173 and a download server 151 may be communicatively coupled via respective communication paths 145, 143, 175, and 153 to the wireless infrastructure 170. Although shown as separate entities, the functions and operations provided by the provisioning server 129, the DM server 109, the diagnostics server 173 and the download server 151 may be implemented using a single server, or on multiple servers co-located or separately located, depending upon anticipated load, economics, server capability, or other factors, for example.

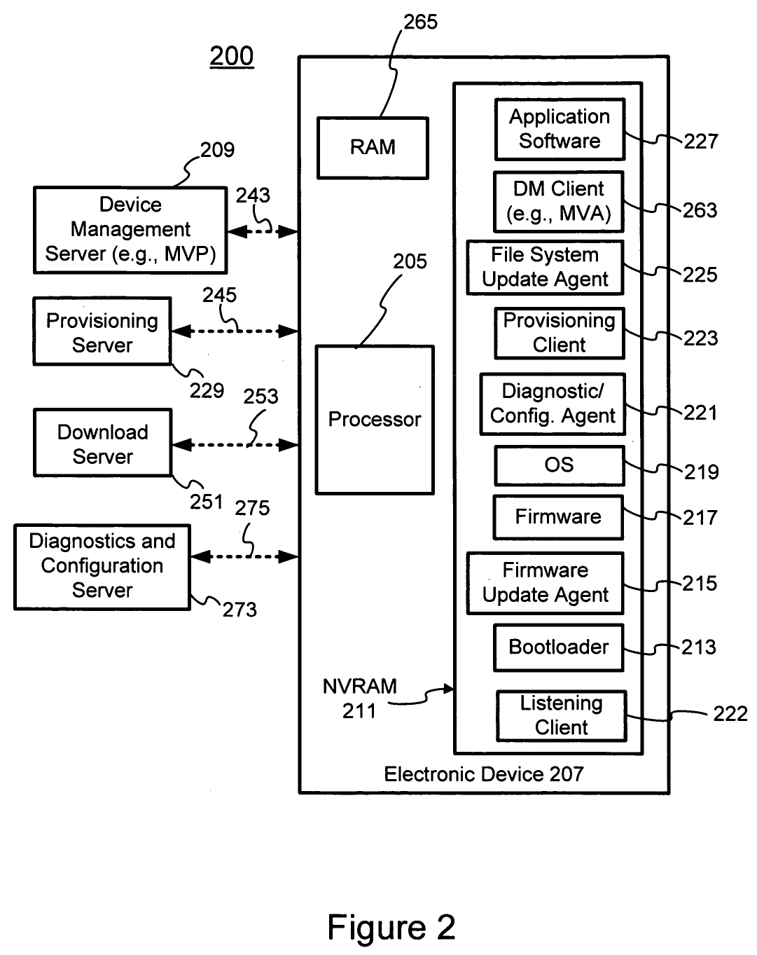

FIG. 2 is a block diagram of an exemplary network 200 that is capable of monitoring, diagnosing, and resolving issues associated with the operation of an electronic device 207 corresponding to, for example, the electronic device 107 of FIG. 1, in accordance with a representative embodiment of the present invention. In a representative embodiment, the network 200 may enable mass distribution of firmware and/or software updates to fix problems that have been diagnosed within electronic devices such as the electronic device 207 of FIG. 2, for example. As illustrated in FIG. 2, the network 200 comprises a device management (DM) server 209, a diagnostics/configuration server 273, a download server 251, and a provisioning server 229, that may correspond to, for example, the DM server 109, diagnostics/configuration server 173, download server 151, and provisioning server 129 of FIG. 1. The device management (DM) server 209, diagnostics/configuration server 273, download server 251, and provisioning server 229 may be communicatively coupled to the electronic device 207 to enable the device management (DM) server 209, diagnostics/configuration server 273, download server 251, and provisioning server 229 to cooperate in providing management/diagnostic services and functions for the electronic device 207. The electronic device 207 may comprise any of a number of different portable/handheld/mobile electronic devices such as, for example, a cellular/wireless telephone, a personal digital assistant (PDA), and a pager. In a representative embodiment of the present invention, the electronic device 207 may comprise non-volatile memory 211 that may, for example, comprise NAND or NOR flash memory, battery-backed memory, electrically programmable read-only memory (EPROM), or various other suitable forms of non-volatile memory. In the representative embodiment of FIG. 2, the non-volatile memory 211 of the electronic device 207 comprises a number of firmware/software components such as application software 227, a device management (DM) client 263 which may be alternatively described as a mobile variance agent (MVA) hereinafter, a file system update agent 225, a provisioning client 223, a diagnostic/configuration agent 221, an operating system (O/S) 219, firmware 217, a firmware update agent 215, a bootloader 213, and a listening client 222. The electronic device 207 also comprises a random access memory 265 and a processor 205. The random access memory 265 may be used to store data and/or instructions/codes when the processor 205 executes the various clients, agents, and application software 227, 263, 225, 223, 221, 219, 217, 215, 213, 222 stored in the non-volatile memory 211. The firmware/software 227, 263, 225, 223, 221, 219, 217, 215, 213, 222 resident in the non-volatile memory may be designed to conform to an Open Mobile Alliance (OMA) device management (DM) standard and/or protocol, for example, or any proprietary standard and/or protocol. One or more of these various clients, agents, and application software 227, 263, 225, 223, 221, 219, 217, 215, 213, 222 may be used for communicating to any one of the servers 209, 229, 251, 273 during a monitoring, diagnosing, repair, and/or update process. Although shown separately in FIG. 2, the provisioning client 223 may be implemented within the diagnostic/configuration agent 221 in one or more other representative embodiments.

The electronic device 207 may apply updates using the firmware update agent 215 and/or file system update agent 225, each of which is capable of processing one or more update packages or portions and/or subsets thereof. The listening client 121 may be capable of listening to a broadcast channel and it may initiate downloading an update package broadcast by using the provisioning (or broadcast) server 129. The electronic device 207 may receive update packages, for updating the contents of the non-volatile memory 211 of the electronic device 207 by way of using the firmware update agent 215 and/or file system update agent 225. The firmware update agent 215 and/or file system update agent 225 may be capable of updating any of the firmware/software, operating system 219, and bootloader 213 in the electronic device 207 including, for example, the diagnostic/configuration agent 221 that facilitates remote diagnosis of the electronic device 207. The operating system 219 may comprise any one of the following operating systems, for example: Symbian (versions 6.0, 6.1, 7.0, 7.0s), Microsoft Smartphone 2002 & 2003, Microsoft Pocket PC 2002 & 2003, Palm v4.0 and higher, RIM (Blackberry) v3.6 and higher, and selected J2ME devices with MIDP 2.0.

As shown in FIG. 2, the electronic device 207 may comprise a DM client 263 that is capable of interacting with, for example, the DM server 209, the provisioning client 223, and the diagnostic/configuration agent 221. In a representative embodiment of the present invention, the DM client 263 may receive device management commands from, for example, the DM server 209, and may implement the received DM commands on the electronic device 207. The DM commands may, for example, comprise elements of the OMA Device Management (DM) protocol being developed under the auspices of the Open Mobile Alliance Ltd. Such protocol elements may support the management (e.g., creation, setting, updating, retrieving, and deletion) of information stored as managed objects in a device management structure (e.g., a device management (DM) tree) in the memory of the electronic device 207.

In a representative embodiment of the present invention, a download server such as, for example, the download server 251 of FIG. 2 may download firmware and/or software updates (e.g., by way of one or more update packages) to the electronic device 207 via the communication path 253, for later application to the memory of the electronic device 207.

A representative embodiment of the present invention may comprise a provisioning server 229 that may be used to facilitate communication of provisioning information (e.g., service-related parameters, device-parameters, user preferences), using, for example, an over the air (OTA) delivery mechanism via the communication path 245.

Although the communications paths 243, 245, 253, 275 are shown as being separate, this is not a specific limitation of the present invention. The communications paths 243, 245, 253, 275 may connect to a common access point using a wireless infrastructure, such as that presented in FIG. 1. The communication paths 243, 245, 253, 275 may comprise a dedicated wired or wireless communication link such as, for example, an intranet, the Internet, a wired or wireless local area network, a packet network, or any other suitable form of communication link. In another representative embodiment, the functionalities provided by any of the diagnostics/configuration server 273, device management (DM) server 209, download server 251, and provisioning server 229 may be combined using a single or a number of servers. The servers 273, 209, 251, 229 may be communicatively coupled to any one or more of the other servers 273, 209, 251, 229.

In a representative embodiment of the present invention, the electronic device 207 may be capable of updating the contents of the non-volatile memory 211 in the electronic device 207 such as, for example, the application software 227, operating system (OS) 219, or firmware 217, by employing an update package delivered by, for example, the download server 251 via communication path 253. An update package used for updating the electronic device 207 may be produced by a generator (not shown), and may comprise a set of instructions executable by processor 205 of the electronic device 207 to convert/transform an existing code version to an updated code version in the non-volatile memory 211 of the electronic device 207. The generator may be located at a facility such as manufacturing facility or at a location within the wireless infrastructure mentioned in relation to FIG. 1. Additional details of the generation and application of update packages may be found in the PCT Application with publication number WO/02/41147 A1, PCT number PCT/US01/44034, filed Nov. 19, 2001, and in U.S. Provisional Patent Application Ser. No. 60/249,606, filed Nov. 17, 2000, the complete subject matter of each of which is hereby incorporated herein by reference, in its entirety.

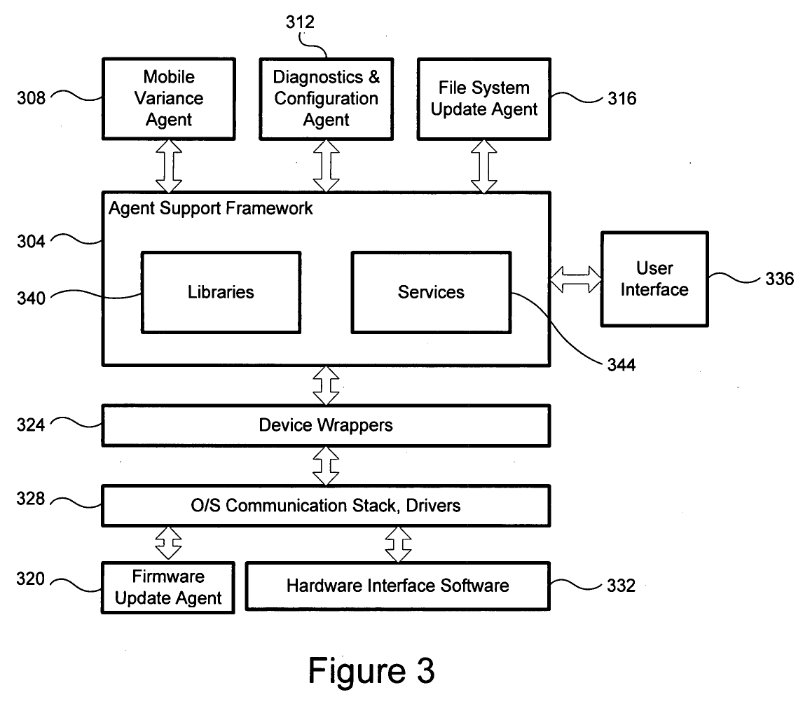

FIG. 3 is a relational block diagram illustrating various modular software components integrated within an exemplary software platform of an electronic device, such as the electronic device previously described in relation to FIGS. 1 and 2, in accordance with an embodiment of the invention. The various modular software components comprise an agent support framework 304, one or more agents 308, 312, 316, 320, device wrappers 324, an operating system (O/S) communication stack and drivers 328, a hardware interface software 332, and a device user interface 336. In the representative embodiment of FIG. 3, the one or more agents comprise a mobile variance agent 308, a diagnostics and configuration agent 312, a file system update agent 316, and a firmware update agent 320. The agent support framework 304 comprises libraries 340 and services 344. Through the use of the agent support framework 304, the one or more agents 308, 312, 316, 320 are able to share resources provided by the libraries 340 and services 344. The one or more agents have access to one or more specific libraries 340, services 344 and interfaces in order to perform specific tasks assigned to a particular agent. The tasks may be invoked during a device management session initiated by a telecommunications operator or by a user via the device user interface 336. The device user interface 336 may comprise any input device such as a voice controlled input device, or any tactile input device such as a keyboard, for example.

The agents 308, 312, 316, 320 that are illustrated in the embodiment of FIG. 3 are not intended to limit the number and type of possible agents used in the present invention. In other embodiments, one or more agents of varying functionalities may be used in accordance with the spirit of the present invention. The mobile variance agent 308 may communicate with its corresponding server (as previously described in reference to FIGS. 1 and 2) to facilitate device discovery and firmware and/or file system related downloads. The downloads may comprise one or more firmware and/or file system update packages, for example. The diagnostics and configuration agent 312 may communicate with one or more servers (as previously described in reference to FIGS. 1 and 2) to retrieve comprehensive device information and to provision one or more device settings. The file system update agent 316 may be used to resolve and manage file system issues by updating the contents of firmware/software related to the electronic device's file system into memory of the electronic device. The firmware update agent 320 may be used to resolve and manage various firmware/software issues by updating the firmware/software into the memory of the electronic device. The memory may comprise the non-volatile memory previously described in relation to FIG. 2. Each of the one or more agents 308, 312, 316, 320 may be integrated independently from, or in conjunction with, other agents 308, 312, 316, 320. As each agent is integrated, corresponding libraries 340 and services 344 may be accessed and utilized. One or more application programming interfaces (API's) may be accessed by each of the agents 308, 312, 316, 320. The agent support framework 304 and one or more agents 308, 312, 316, 320 provide a modular software approach that provides distinct advantages over discrete non-modular implementations. These advantages include a reduction of memory resources, in that services 344, libraries 340, and API resources may be shared between the one or more agents, such that duplication of code is minimized. Further, the agent support framework 304 ensures that only qualified agents gain access to specific device resources and/or interfaces, for example. The modular software approach provided by the various aspects of the invention facilitates extendibility of additional agents into the device platform. For example, newly introduced agents may be integrated into the agent support framework using a phased approach, with minimum impact on existing software, and with reduced integration time. In many instances this may be achieved over-the-air (OTA). The various agents and the agent support framework may utilize standards based protocols, such as those specified by the Open Mobile Alliance (OMA).

In a representative embodiment, the mobile variance agent (MVA) 308 may comprise an embedded client that provides OMA based communications with one or more servers, such as the device management (DM) server. The mobile variance agent (MVA) 308 may also be referred to as a device management client or agent. Hereinafter, the device management server may be alternatively referred to as a mobile variance platform (MVP). Among other things, the MVA 308 may conduct, wholly or partially, a discovery session with an electronic device, a software object download, a notification to an application or user via SMS (short messaging service) required for initiating a WAP (wireless application protocol) push session, an initiation of a firmware or file system update session, and communication with one or more remote servers to indicate the status of the update session. The MVA 308 may support device management sessions such as those used during firmware over-the-air updates in a flexible manner, according to a defined set of events. There are several use-case scenarios that may be described by such events, which may be of interest to a particular network operator or electronic device manufacturer, and may be customized and managed by the agent support framework. These scenarios may be related to end-user interaction, end-user notification, and session management, for example. End-user interaction may relate to the possibility for the end-user to accept, reject, defer or cancel a firmware OTA update session, for example. End-user notification may relate to notice of receipt of push SMS messages, update package download descriptor, download progress, and update status/progress. Session management may relate to the expiration of timers, restoring lost connections, and resetting agents, for example.

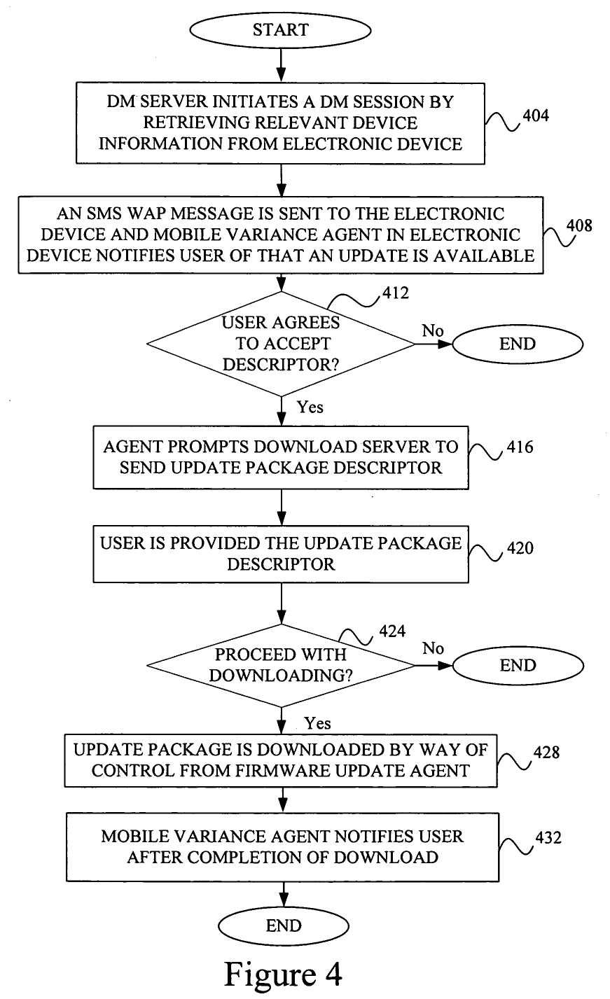

FIG. 4 is an operational flow diagram showing an exemplary firmware over-the-air (OTA) session between an electronic device and one or more servers in a network, in accordance with an embodiment of the present invention. The network may comprise the network previously described in relation to FIG. 2. The network may comprise a wireless network supported by a telecommunications carrier, for example. The operational flow diagram describes a typical discovery, reporting, and software update package download process. At step 404, a device management (DM) server initiates a device management session by retrieving relevant current device information from the electronic device. Next, at step 408, a message is sent to the electronic device from the one or more servers in the network. The message may comprise an SMS wireless application protocol (WAP) message or HTTP message, for example. The mobile variance agent (MVA), as previously described in relation to FIG. 3, may notify or prompt the user that an update is available, for example. Thereafter, at step 412, the user may agree to accept a descriptor of the update. If the user agrees to accept the descriptor, the process continues with step 416. Else, the process ends. The user may accept the descriptor by inputting a command using a user interface of the electronic device, for example. At step 416, the MVA prompts a download server, for example, to send the update package descriptor. At step 420, the update package descriptor is received by the electronic device and is displayed to the user. After reviewing the update package descriptor, at step 424, the user may elect to proceed with downloading the corresponding update package. If the user elects to proceed with the download, the process continues with step 428; else, the process ends. At step 428, the update package is downloaded by way of control provided by the mobile variance agent (MVA) and/or firmware update agent. Next step 432, the mobile variance agent notifies the user after the firmware update agent has successfully completed the download.

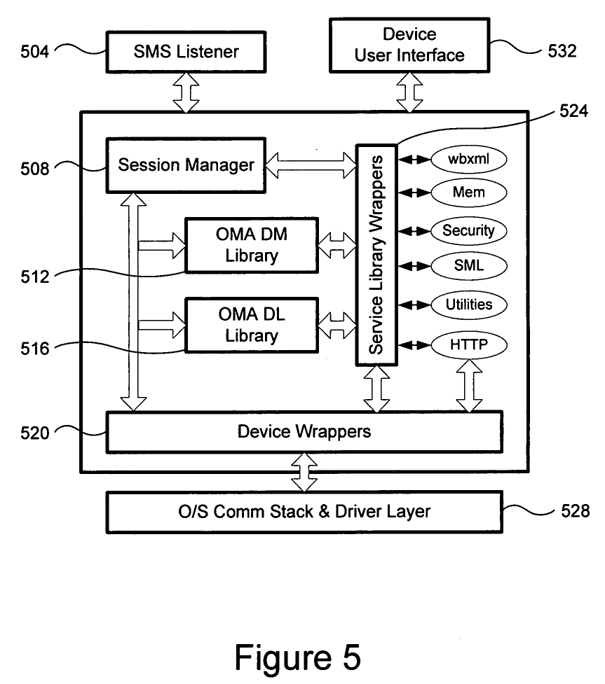

FIG. 5 is a functional block diagram illustrating the various modular software components in an exemplary software platform of an electronic device used in conjunction with a mobile variance agent (MVA), in accordance with an embodiment of the present invention. As was mentioned in reference to FIG. 3, the various modular software components comprise an agent support framework. The MVA may be used in conformance with one or more standards and/or protocols specified by the Open Mobile Alliance (OMA), for example. The electronic device may correspond to the electronic device 107 of FIG. 1 or the electronic device 207 of FIG. 2, for example. The block diagram comprises an SMS listener 504, a session manager 508, an OMA device management (DM) library 512, an OMA download (DL) library 516, a device wrappers module 520, a service library wrappers module 524, an O/S communication stack and driver layer 528, and a device user interface 532. In a representative embodiment, the MVA and agent support framework may occupy a ROM footprint of approximately 120 Kbytes. In a representative embodiment, the RAM heap may occupy approximately 65 Kbytes. The agent support framework may include all libraries and service wrappers used by the MVA. Due to the modular and flexible architecture of the agent support framework, the various modular software component interfaces are well defined and may be customized during integration to meet unique requirements. During initialization, the SMS listener 504 monitors inbound SMS traffic that contains a specific header. The SMS traffic may comprise a SMS WAP push message transmitted by a server by way of a wireless infrastructure (such as that described in relation to FIG. 1) owned by a telecommunications operator, for example. The session manager 508 may comprise an intelligent state machine that processes SMS messages, parses external events, and initiates actions based on the status of those events. In a representative embodiment, the OMA DM library 512 and the OMA DL library 516 may provide full OMA firmware over-the-air support. The DM library 512, for example, may provide discovery and notification during a firmware OTA update, and may be compliant with OMA standards. The DL library 516 may facilitate update package descriptor downloads and the associated update package object downloads used for a firmware OTA update, and may be compliant with OMA standards. Various aspects of the invention also provide an alternative OMA download method that may be used to provide support during a download resume, in the event of an interrupted object download due to loss of wireless coverage or service, for example. The service library wrappers module 524 may comprise interfaces that allow device manufacturers to interface with service libraries for enabling memory management, HTTP, security, or for referencing existing functions. The device wrappers module 520 may be used to provide device wrappers or device wrapper templates that identify a function call to the operating system of an electronic device and may associate a device layer required by one or more OMA DM or OMA DL libraries 512, 516. The device wrappers may facilitate use of one or more functions that may be provided by the OMA DM and/or OMA DL libraries 512, 516 to provide storage of one or more device configuration parameters. The device wrappers may facilitate the implementation of methods for executing specific OMA commands in the device (such as those required for a firmware OTA update session, for example). The device wrapper may also facilitate generation of socket layer interfaces. The MVA may rely on available device API's to provide one or more necessary tasks. The MVA may interface with the O/S communication stack and driver layer 528. The MVA may also provide a number of additional interfaces that may be defined and/or customized during integration, such as an SMS listener interface 504 that may be used for WAP push message receipt, parsing and handling. The MVA may provide a device layer interface used for configuring timers, battery states, parameter storage, and the like. The MVA may also provide a service layer interface related to HTTP, security, and standard library functionality. The MVA may provide a firmware OTA handoff interface to initiate firmware and file system updates, and to update status notification to a DM server. The OMA DM library 512 and the OMA DL library 516 may also provide security features such as HTTPS/SSL/TLS (i.e., HTTP over SSL, secure socket layer, transport layer security), for example.

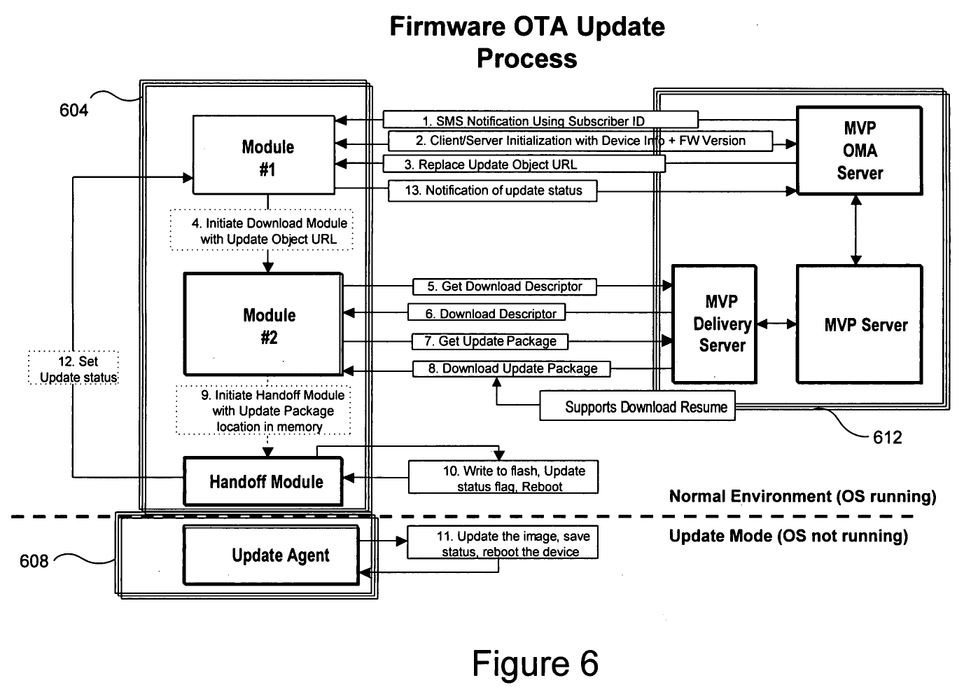

FIG. 6 is an operational block diagram that illustrates an exemplary operation of an MVA 604 with its corresponding server 612, in accordance with an embodiment of the present invention. FIG. 6 may be used to supplement and/or further describe the operational flow diagram previously presented in FIG. 4, in accordance with an embodiment of the present invention. The server 612 may comprise the MVP or DM server previously described in reference to FIG. 2. The MVA 604 may be used in an electronic device such as that presented earlier in reference to FIGS. 1 and 2. The MVA 604 may comprise one or more modules, each of which provides a particular function. The MVP 604 may communicate with an update agent 608, as shown. The update agent 608 may comprise a firmware update agent or file system update agent, for example. As shown at step 1, the server 612 may transmit an SMS notification to the MVA 604 by using subscriber identification (ID) information. The notification may indicate that a firmware update is available. At step 2, the initialization process may begin by way of exchanging device information, including firmware version currently used by the device. Next, at step 3, it is determined that an object URL is to be replaced, for example. At step 4, Module #1 within the MVA 604 may as a consequence, initiate a download using the updated object URL, for example. Thereafter, at step 5, a descriptor (i.e., a description of the update package) may be requested by the MVA 604. At step 6, the descriptor is subsequently downloaded from the server 612 at step 6. Next at step 7, Module #2 of the MVA 604 requests an update package from the server 612. The update package is downloaded at step 8. At step 9, the server 612, in response, transmits the update package to Module #2 of the MVA 604. Module #2 initiates a handoff to the handoff module by specifying a location in non-volatile memory in which the update package is to be stored. The non-volatile memory, for example, may comprise a NOR or NAND flash memory. Next at step 10, the update is written into the flash memory, a status flag is updated, and the operating system of the electronic device may be rebooted. Subsequently, at step 11, the memory image may be updated, the current state is saved into memory, and the electronic device may be subsequently rebooted. The result of the update is set in Module #1 at step 12. In a representative embodiment, the operating system of the electronic device may not run when the MVA operates in firmware/software update mode.

A diagnostics/configuration agent, as previously mentioned in reference to FIG. 2, may comprise a thin client application that is capable of retrieving comprehensive information from a device to assist with remote customer care. The diagnostics/configuration agent may be used to reduce device support costs, improve end-user experience, obtain market intelligence data and perform electronic device configuration. Among other things, the diagnostics/configuration agent and its corresponding diagnostics/configuration server provide a fully customizable end-to-end device management solution that provides a number of benefits. The diagnostics/configuration server may be used to profile an electronic device. The diagnostics/configuration server may retrieve detailed information, such as one or more configuration parameters pertaining to the electronic device. Further, the diagnostics/configuration server may provide automatic retrieval and analysis of electronic device information, thereby reducing the level and amount of support required by customer representatives. Additionally, use of the diagnostics/configuration server shortens the amount of time required to diagnose device issues, providing a reliable mechanism by which repeat issues may be resolved without a duplication of effort. As a result, support costs may be significantly reduced. The diagnostic/configuration agent provides an improved end-user experience by way of performing automatic profiling of extensive data within the electronic device (e.g., a mobile handset). This data may be easily transmitted to a remote server during customer care call. As a consequence, end-users are no longer required to have a detailed knowledge of their mobile handset. Other benefits of using the diagnostics/configuration agent of the present invention include automatic investigation and resolution of any electronic device issues with minimum end-user interaction. Other benefits include the possibility of transparently profiling an end-user subscriber base to extract pertinent data that might assist in understanding customers needs, usage trends. Such marketing data may be used for improving products and services. For example, it may be possible to profile all handsets owned by 25-35 year old end-users to determine what applications have been downloaded into the file system of the electronic device. The data may be used to recommend similar products for purchase and download by a user. Additional benefits related to automatic configuration adjustment of the electronic device. The diagnostic/configuration agent may provide the ability to determine and correct various configuration settings. For example, this may be achieved over SMS in the event that an HTTP session cannot be established.

The diagnostics/configuration agent may continually check and/or reconfigure settings of the electronic device. Even while the electronic device is in a sleep state, a change in the settings may be triggered by an external event such as a request by the diagnostics/configuration server to perform OTA troubleshooting.

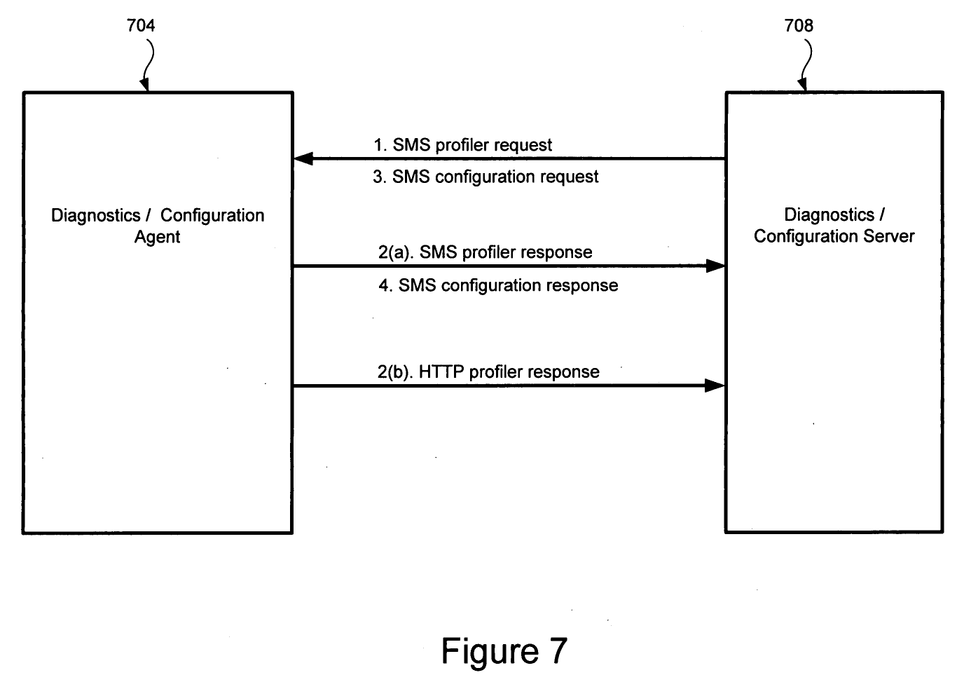

FIG. 7 is an operational block diagram illustrating an exemplary diagnostics and configuration session provided by a diagnostics/configuration agent 704 and its corresponding diagnostics/configuration server 708, in accordance with an embodiment of the invention. At step 1, the diagnostics/configuration server 708 sends a profiler request to the diagnostics/configuration agent 704. At step 2, the diagnostics/configuration agent 704 retrieves a profile comprising a comprehensive set of device data. The diagnostics/configuration agent 704 may transmit the device data by way of a) a proprietary SMS sequence (up to several messages), if an HTTP connection cannot be established or b) by way of HTTP, if an appropriate connection is available. Next at step 3, the diagnostics/configuration agent 704 and its corresponding server 708 may analyze the received data to check its various device settings, such as its communication protocol (e.g., GPRS) and e-mail settings, for example, and may initiate a configuration request by sending the correct parameters to the device over SMS (or HTTP if available). At step 4, the diagnostics/configuration agent 704 may apply the corresponding configuration parameters to the electronic device, and appropriately may execute other control parameters (such as a device reset); then the diagnostics/configuration agent 704 may send an acknowledgement response to the server 708 that the configuration of the device is complete, by way of SMS (or HTTP if available).

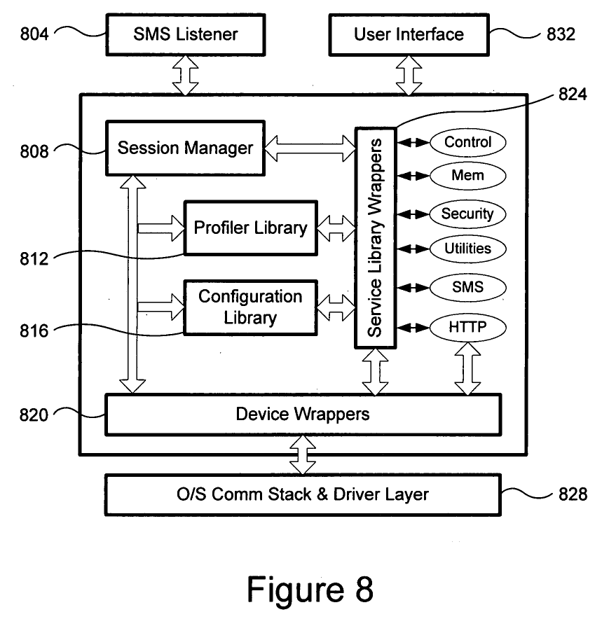

FIG. 8 is a functional block diagram illustrating the various modular software components in an exemplary software platform of an electronic device used in conjunction with the diagnostics/configuration agent, in accordance with an embodiment of the present invention. As was mentioned in reference to FIG. 3, the various modular software components comprise an agent support framework. The diagnostics/configuration agent may be used in conformance with one or more standards and/or protocols specified by the Open Mobile Alliance (OMA), for example. The electronic device may correspond to the electronic device 107 of FIG. 1 or the electronic device 207 of FIG. 2, for example. The block diagram comprises an SMS listener 804, a session manager 808, a profiler library 812, a configuration library 816, a device wrappers module 820, a service library wrappers module 824, an O/S communication stack and driver layer 828, and a device user interface 832. The diagnostics/configuration agent is a device resident background application that may be triggered by a unique incoming SMS message, which is initiated by its corresponding diagnostics/configuration server, to perform OTA diagnostics and configuration. There are several key components to the diagnostics/configuration agent that are illustrated in FIG. 8. During initialization, the SMS listener 804 may monitor inbound SMS traffic for a specific header. Specific messages may be re-routed for handling by the session manager 808. It is possible to store or delete incoming SMS messages and provide audible or visual notification when such messages are received. The session manager 808 may decrypt and authenticate an SMS message to a specific network operator authentication code, and may subsequently determine the message type ID. The message type ID may indicate any number of different messages. The message type ID may indicate a profile request message that may be used to activate a response to the server and to subsequently activate device profiling. The SMS message may then be parsed to build a list of parameters to be profiled. The message type ID may indicate a “keep alive” request message used for activating a simple response to the server. The message may comprise a configuration request message used for configuring the device using an argument provided by the diagnostics/configuration server. The session manager 808 may also handle device control functions such as a soft reset, for example. The session manager 808 may also conduct communications with the diagnostics/configuration server. The preferred method for communicating with the diagnostics/configuration server may be specified in the request message, as either a) SMS, wherein the diagnostics/configuration agent uses SMS as the method of transport, b) HTTP, wherein the electronic device uses any available internet connection as the method of transport, and c) Auto, wherein the diagnostic/configuration agent may first attempt to use TCP/IP as the primary mode of communication, but may revert back to SMS if TCP/IP mode fails. The profiler library 812 may gather device information and prepare profiling data for transmission to the diagnostics/configuration server. Since the profile information may vary across different platforms or devices, the data may be divided into common data and device specific data. Some examples of the type of data that may be profiled in the electronic device may include the type of applications, hardware, memory, subscriber information, connection settings, e-mail, WAP, SMS, and MMS settings used by the electronic device. The type of hardware may be specified or described by platform, manufacturer, model and version, processor type and speed. The type of memory profiled may be specified in terms of internal memory type: [C:] drive, ROM, RAM, total memory sizes, available memory, and the like. Subscriber information may include, for example, cell ID, country code, location area code, network country code, signal strength, battery strength, service center address, and the like. The connection settings may be profiled using access point name, user name, password, and the like. Email, WAP, SMS and MMS settings may be profiled using account and connection parameters. The type of software applications used by a user may be profiled by providing the type of installed applications, and by providing program status associated with the electronic device.

The firmware update agent and file system update agent, previously described in FIG. 3, may be triggered during an OMA firmware OTA session, for example. The update agents may process an update package to rewrite the firmware, software, and content in a secure, fault-tolerant manner. The update agents permit the entire firmware and software of a device to be updated over-the-air, thereby significantly reducing warranty and support costs. This capability provides the ability to add services and functionality to devices that have already been deployed. Further, software bugs may be repaired remotely.

As was mentioned in reference to FIG. 2, a generator is used to generate an update package. The update package may comprise a firmware update package or a file system update package, for example. The generator comprises an application that may be run in a Windows, Linux or Unix environment, for example, and may be used to compare two firmware images or files within a file system. The sizes of the update packages largely depend on the amount of change between firmware versions, especially new data. A command line interface (CLI) may be utilized to run the generator, which may be utilized in a commercial build environment to automate the update package creation process. After it is generated, the update package may be sent to a device management (DM) server (alternatively described as a Mobile Variance Platform (MVP)) within a network of a telecommunication operator where it may be stored for future use. The MVP and the DM server may conform to OMA standards or any proprietary standard. The update package may comprise necessary instructions to transform a source image into a target image. The update package may also contain processing instructions and meta-data for correctly processing the update package. The instructions and meta-data may be used to ensure that code is not overwritten prematurely during the update process. In a representative embodiment, the firmware and file system of the electronic device may be updated using a single update package. Update packages may be transmitted from the MVP to one or more electronic devices, wherein an agent such as a mobile variance agent (MVA) as previously discussed may be used to interface with the MVP. The MVP or DM server may handle tasks such as lifecycle management and delivery of update packages to mobile electronic devices. The MVA may be responsible for triggering the update process, discovering available updates, downloading appropriate updates, and finally, handing off the process to the firmware update agent or file system update agent. The firmware update agent may comprise a micro client that resides below the operating system but directly above the boot sector, as may be referenced in the software platform of FIG. 3. The firmware update agent processes an update package and rewrites the firmware in a secure, fault-tolerant manner.

The file system update agent may be used to update files within devices that utilize a file system. Although the file system update agent may be invoked before or after a firmware update has been completed, it is contemplated that a file system update is completed after a firmware update has been completed in order to ensure that any firmware dependent drivers used by the file system are also updated. During an update, the file system update agent may process headers within the update package. A file system update may also provide various software hooks for files to be subsequently added, modified, or deleted.

The firmware and/or file system update agents may decrypt a digital signature of the update package to verify that it has not been tampered with at any point after it was created. The update agents may verify a firmware image that is generated by the electronic device by calculating hash values of the image and comparing them against “known good data” stored in the update package. The update agents insure that the correct update package is applied to the device.

After validating an update package, the update agent may interpret the instructions contained in the update package and apply them to the actual firmware stored in the electronic device. The process employs appropriate redundancy measures to ensure recovery in the case of power loss during the update process. Once completed, the final firmware image may be verified and the device may be restarted such that the new firmware is operational.

The firmware update agent is a comprehensive software client that provides a wide range of functionality. The update agent ensures safe, reliable updates using fault-tolerant techniques. Various techniques are employed to eliminate the possibility for subscribers to inadvertently damage their devices when a user attempts to reset his phone or remove a battery during a firmware rewrite process.

One or more security validation functions have been incorporated into the update agents to ensure that any unauthorized tampering of the update package is detected prior performing a firmware or file system update. The update agents may use a public key embedded in the electronic device, either at the hardware level or firmware level, to decrypt the digital signature that is applied during generation of the update package. The update agents may be used to calculate an MD5 message-digest of an update package. Subsequently, the MD5 message-digest may compare this against the ‘known good data’ stored in the digital signature in order to validate the package. The MD5 algorithm is only one example of a security validation function and the update agent may incorporate other algorithms, such as SHA-X, as required by a device manufacturer or network operator.

In order to provide product enhancements to electronic devices that are already in the market, the update agent itself may be configured to be self-updatable, such that it may update itself using a firmware image generated during an update package download. Thus, the update agent may adapted to accommodate changes to other software components within the electronic device as well. The update agent may be configured to be fault tolerant. When power interruption occurs, an update will continue from the point at which an update process was interrupted.

When using memory (RAM) constrained devices it may be necessary to reduce the amount of RAM required during an update process by using “streaming decompression”. The update package may be decompressed to its RAM in its entirety, but if the size of the decompressed update package exceeds that of the available RAM space in the device, a streaming decompression process may be applied. Streaming decompression provides the ability to decompress the update package incrementally before applying the update to the non-volatile memory, thus minimizing the amount of RAM required.

An update agent may be configured to track all pre-existing and runtime blocks of memory that have been identified as bad blocks. The update process may be performed entirely in RAM, and may use less RAM than a NAND flash image size since any physical blocks that are not bad blocks, may not be utilized.

An update agent may utilize its own device drivers, security libraries, and memory management functions. Because it is completely independent of the device's resident operating system, an update agent may be completely platform agnostic and easily portable across different electronic devices. An update agent may store multiple flash chip driver libraries, and automatically use the appropriate driver by detecting which flash chip is installed in the device. This provides assurance to manufacturers that the update agent is compatible with all makes and models of electronic devices.

Aspects of the present invention, related to the electronic device or the one or more servers may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention, such as the modular software components described within, may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method of providing over-the-air (OTA) monitoring and servicing to an electronic device comprising:
transmitting current device information from said electronic device to one or more remote servers; and
receiving one or more services from said one or more remote servers based on said current device information.

2. The method of claim 1 further comprising receiving a notification from said one or more servers indicating that a firmware/software update for said electronic device is available before said receiving said one or more services occurs.

3. The method of claim 2 wherein said notification comprises an SMS message.

4. The method of claim 2 wherein said notification comprises an HTTP message.

5. The method of claim 2 further comprising transmitting a request from a user of said electronic device to accept a descriptor of said firmware/software update before said receiving occurs.

6. The method of claim 5 comprising receiving said descriptor from said one or more remote servers before said receiving said one or more services occurs, said descriptor providing additional information about said firmware/software update.

7. The method of claim 1 wherein said electronic device comprises a mobile communications device.

8. The method of claim 7 wherein said mobile communications device comprises a cellular telephone.

9. The method of claim 1 wherein said device information comprises current firmware information and said one or more services comprises providing a firmware update.

10. The method of claim 1 wherein said device information comprises current subscriber information and said one or more services comprises provisioning one or more settings of said electronic device.

11. The method of claim 10 wherein said subscriber information comprises one of the following: cell ID, country code, location area code, network country code, signal strength, battery strength, service center address.

12. The method of claim 10 wherein said one or more settings comprises one of the following: e-mail, WAP, SMS, and MMS settings.

13. The method of claim 1 wherein said device information comprises a type of hardware used by said electronic device.

14. The method of claim 1 wherein said device information comprises a type of memory used by said electronic device.

15. The method of claim 1 wherein said device information comprises connection settings comprising one of the following: access point name, user name, and/or password.

16. An electronic device supporting over-the-air (OTA) monitoring and servicing, said electronic device comprising:
a random access memory for storing data;
a non-volatile memory comprising one or more software agents; and
a processor for executing said one or more software agents using said random access memory, said one or more software agents used for interfacing with one or more servers that are communicatively coupled to said electronic device, said one or more servers capable of wirelessly transmitting firmware updates to said electronic device.

17. The system of claim 16 wherein said non-volatile memory comprises a flash memory.

18. The system of claim 16 wherein said electronic device comprises a cellular telephone.

19. The system of claim 16 wherein said electronic device comprises a personal digital assistant (PDA).

20. The system of claim 16 wherein said one or more servers are capable of provisioning one or more settings of said electronic device.

21. The system of claim 16 wherein said one or more software agents utilize a set of libraries and services commonly used in different makes and models of said electronic device.
